(19) United States
(12) Patent Application Publication
(10) Pub. No.: US 2014/0314930 A1
(43) Pub. Date: Oct. 23, 2014

(54) ACCELERATED PRODUCT AGING

(71) Applicant: Alexander NASSIEF, Miami, FL (US)

(72) Inventor: Alexander NASSIEF, Miami, FL (US)

(21) Appl. No.: 14/250,027

(22) Filed: Apr. 10, 2014

Related U.S. Application Data
(60) Provisional application No. 61/814,638, filed on Apr. 22, 2013.

(51) Int. Cl. C12H 1/22

(52) U.S. Cl. CPC C12H 1/22
USPC 426/519; 99/277.2

(57) ABSTRACT

Accelerated aging of a product is provided by submerging in a body of water a container having a product to be aged therein. The container is coupled to anchoring device(s) via a coupling apparatus. The anchoring device(s) and the coupling apparatus are operatively configured to limit movement of the container relative to the anchoring device(s) when the container is at least partially submerged in the body of water. Movement of the body of water causes agitation of the container when the container is submerged in the body of water, and the agitation accelerates an aging process of the product in the container. Example products that may benefit from accelerated aging as described herein include alcoholic beverages.

### CROSS REFERENCE TO RELATED APPLICATIONS

This application claims priority under 35 U.S.C. §119(e) to U.S. Provisional Patent Application No. 61/814,638 filed Apr. 22, 2013, entitled “Systems and Methods for Aging Beverages”, the content of which is hereby incorporated herein by reference in its entirety.

### BACKGROUND

Many products, such as beverages, and more particularly alcoholic beverages including spirits, wine, and beer, benefit from an aging process whereby the product is left to age in a vessel for a period of time. Typically, the vessel is specifically selected to impart desired characteristics in the product. In the case of beer, wine, and various spirits such as whisky, oak barrels are commonly used to impart aromatic, flavor, color, and body characteristics in the beverages. An aging process may extend for a long period of time, sometimes for many years. It would be beneficial to accelerate the aging process without adding significant costs.

### BRIEF SUMMARY

Shortcomings of the prior art are overcome and additional advantages are provided through a method to accelerate an aging process. The method includes at least partially submerging, in a body of water, a container having a product to be aged therein; and coupling the container to at least one anchoring device via a coupling apparatus, wherein the at least one anchoring device and the coupling apparatus are operatively configured to limit movement of the container relative to the at least one anchoring device when the container is at least partially submerged in the body of water, and wherein movement of the body of water causes agitation of the container when the container is at least partially submerged in the body of water, the agitation accelerating an aging process of the product in the container.

Additionally, a product-aging apparatus is provided to accelerate an aging process. The product-aging apparatus includes a container having a product to be aged therein; at least one anchoring device; and a coupling apparatus coupling the container to the at least one anchoring device, the at least one anchoring device and the coupling apparatus operatively configured to limit movement of the container relative to the at least one anchoring device when the container is at least partially submerged in a body of water, and to enable, based on movement of the body of water, agitation of the container when the container is at least partially submerged in the body of water, the agitation accelerating an aging process of the product in the container.

Additional features and advantages are realized through the concepts of aspects of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts an example product-aging apparatus to accelerate an aging process of a product, in accordance with aspects described herein;

FIG. 2 depicts another example product-aging apparatus to accelerate an aging process of a product, in accordance with aspects described herein;

FIG. 3 depicts yet another product-aging apparatus to accelerate an aging process of a product, in accordance with aspects described herein;

FIG. 4 depicts a further example of a product-aging apparatus to accelerate an aging process of a product therein, in which multiple containers having one or more products to be aged are coupled together, in accordance with aspects described herein;

FIG. 5 depicts an example of a product-aging apparatus to accelerate an aging process of a product therein, in which multiple movable anchoring devices are coupled to a container having a product to be aged, in accordance with aspects described herein; and

FIG. 6 depicts another example of a product-aging apparatus to accelerate an aging process of a product therein, in which multiple containers having one or more products to be aged are coupled together, in accordance with aspects described herein;

FIG. 7 depicts an example process to accelerate an aging process of a product, in accordance with aspects described herein.

### DETAILED DESCRIPTION

Described herein are processes and apparatuses that provide for non-traditional aging of products, such as beverages, in order to accelerate the aging process for these products. Example beverages for which an accelerated aging process and product-aging apparatus as described herein may be used include alcoholic spirits (such as, but not limited to, rum, whiskey, scotch, cognac, liqueur, vodka, flavored vodka, and brandy), as well as wine, beer, or any other alcoholic beverage. Aspects described herein may also be used to accelerate flavoring processes for non-alcoholic beverages, such as root beer. Additionally, aspects described herein provide non-traditional storage options for products of any kind.

A container having a product stored therein may be submerged, at least partially, into a body of water, such as an ocean, sea, lake, pond, etc. The container may be submerged at a desired depth, which can vary depending on characteristics of the body of water, the product being aged, and various other factors. Submerging the container in a body of water provides many advantages. Storage costs may be lower than land-based storage costs, and product loss due to natural evaporation from the container (as is the case of land-based aging) may be lowered or eliminated. Stable maintenance of a desired temperature is facilitated due to the thermal properties of the body of water as compared to ambient air temperature in the case of land-based aging. Further, currents, waves, and tidal movements of the body of water may provide a natural and low cost means of agitating the container and therefore the product in the container when it is submerged in the body of water. As described below, the container may be coupled to anchoring device(s) via a coupling apparatus made of, for instance, a wire, cable, rope, net, cord, or metal chain configured to allow limited movement of the container relative to the anchoring device(s) by way of movement of the body of water. This natural agitation may accelerate the product's acquisition of characteristics, such as flavor, color, aroma, and body, from the container itself and/or from additives to the container. In this latter regard, the agitation may accelerate interactions between the product and additives added to the container to impart characteristics to the product.

Thus, a product (e.g. beverage) may be placed into a container which itself can act as a flavoring device for the beverage, or into which a flavoring may be added. Example additives include wood, wooden chips, spices, fruit, or fruit products. The container may be prepared for submerging in a body of water by providing it with a water-resistant or waterproof barrier. The container may be wrapped, covered, or encased in plastic or another waterproof or waterproofing material/substance, for instance. In some cases, the container may be prepared with a coating or other barrier selected be at least semi-permeable. This may allow characteristics of the body of water, for instance salinity, to impart itself to some desired level in the product. Alternatively, the container may be placed directly into the body of water without such preparation.

Anchoring device(s), such as one or more blocks, weights, slabs, or other form of anchor, may be placed into the body of water. In one example, the anchoring device(s) are placed or attached to a floor beneath the body of water, for instance the floor of an ocean. The container may be coupled to the anchoring device(s) via a coupling apparatus. The coupling apparatus may include a system of ropes, cables, chains, shackles, hooks, carabineers, cords, nets, and/or other apparatuses. In the case of a net, the net may be configured to contain the container when the container is at least partially submerged in the body of water. The anchoring devices and coupling apparatus prevents drift of the container, while allowing some degree of movement of the container within the body of water.

The coupling apparatus may be optimized so that the container can benefit from agitation by way of movement of the body of water, if desirable. For instance, an amount of length, slack, elasticity, or other configuration of the coupling apparatus may be provided to enable a desired movement of the container relative to the anchoring device(s). In some embodiments, the coupling apparatus is configurable to achieve a desired amount of agitation and/or buoyancy of the container. In general, the greater the agitation enabled by the configuration of the coupling apparatus and anchoring device(s), the greater the acceleration of the aging process, and the quicker and more intense the absorption will be of characteristics from the container or flavor additive.

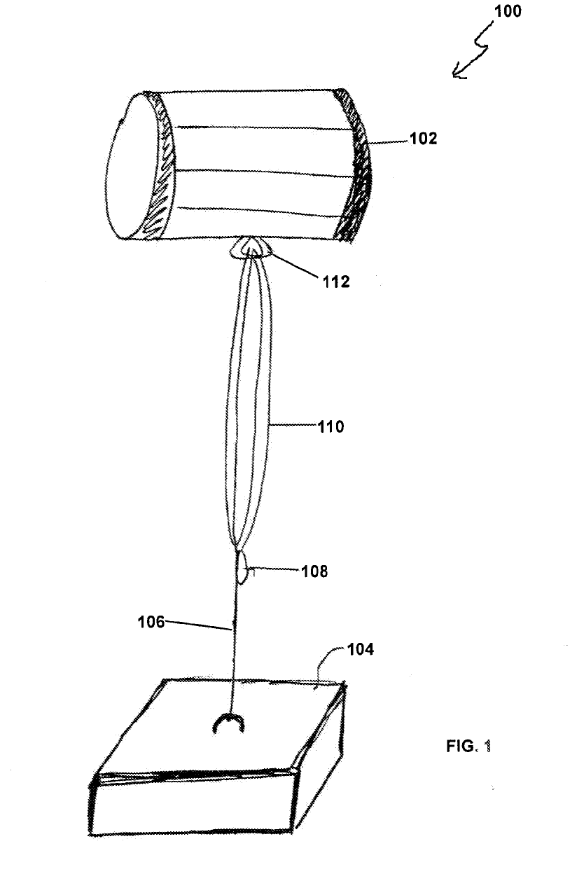

In the example product-aging apparatuses of FIGS. 1-5, one or more containers are attached to a system of ropes, metal chains, and/or metal cables that couple the container(s) to anchoring device(s). Though ropes, chains, and/or cables are used in the examples provided herein, any other appropriate coupling material may be used. Some embodiments may include multiple anchoring devices. Additionally or alternatively, multiple containers may share one or more anchoring devices and be part of a larger product-aging apparatus for aging multiple containers of products.

Referring to FIG. 1, a product-aging apparatus 100 is provided in accordance with aspects described herein. Product-aging apparatus 100 includes container 102 containing one or more products. Container 102 is coupled to an anchoring device 104 using a combination metal chain 106, rope 110, and shackles 108 and 112. Shackle 108 couples metal chain 106 to rope 110, while shackle 112 couples rope 110 to container 102. A shackle may be an eye loop in some embodiments. Components 106, 108, 110, and 112 collectively form a coupling apparatus that couples container 102 to anchoring device 104.

Product-aging apparatus 100 is shown in-situ, meaning that the components thereof are at least partially submerged in a body of water. In this example, the components are fully submerged in the body of water—that is, they are submerged beneath a surface of the body of water. Anchor 104 sits against a floor beneath the body of water. The coupling apparatus acts as a tether against the buoyancy of container 102 or other component of apparatus 100. In this example, the buoyancy will cause container 102 to float substantially above anchoring device 104, though not necessarily on top of the body of water, depending on the depth of the water and length of the coupling apparatus. Anchoring device 104 may be of sufficient weight so as to prevent container 102 from drifting or floating to the surface of the body of water. Additionally or alternatively, anchoring device may be affixed to, or embedded at least partially within, the floor beneath the body of water to keep the anchoring device stationary.

The above configuration allows for agitation of the container, and therefore agitation of the contents contained therein, because the container is subject to motion of the body of water. The length of a portion of the coupling apparatus, such as the length of rope 110, may be adjusted to enable more or less movement of the container with respect to anchoring device. A longer coupling apparatus places the container nearer the surface of the body of water and therefore subjects the container to a greater amount of the agitation by the surface motion of the body of water. The motion of the body of water may be tidal or current movement of the body of water, such as ocean waves. The container may be caused to move back and forth (in the horizontal direction in this example), thereby agitating the container's contents and accelerating the aging process to impart desired characteristics to the product being aged.

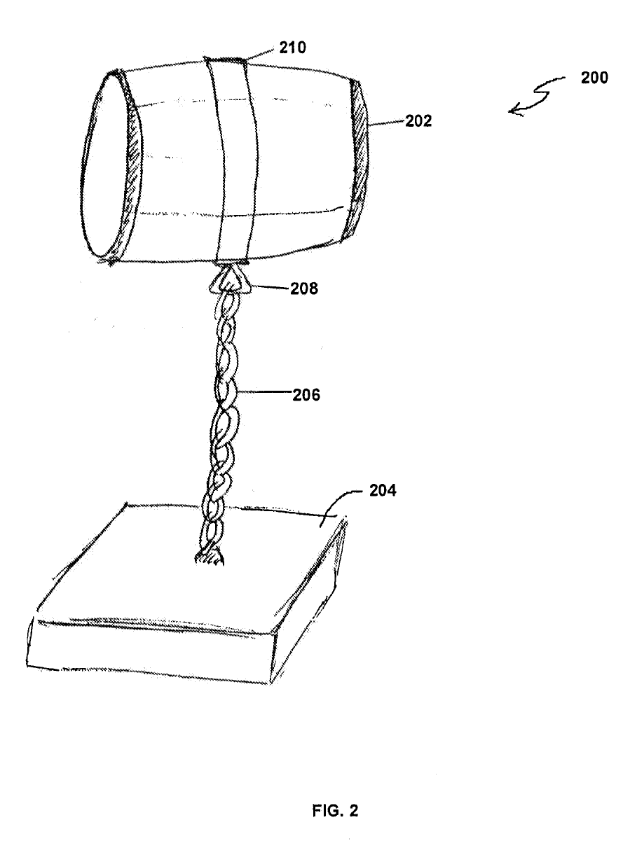

FIG. 2 depicts another example product-aging apparatus to accelerate an aging process of a product, in accordance with aspects described herein. Product-aging apparatus 200 again includes a container 202 containing one or more products. Container 202 is coupled to an anchoring device 204 using a combination metal chain 206 and shackle 208. In this example, shackle 208 is attached to a band or cable 210 that surrounds container 102. Collectively, components 206, 208 and 210 form a coupling apparatus coupling container 202 to anchoring device 204. Band 210 securely wraps around container 202 and connects at shackle 208. Band 210 may be a weight belt, or other buoyancy-adjusting device, to facilitate adjusting buoyancy of the container, in order to achieve a desired amount of agitation of the container.

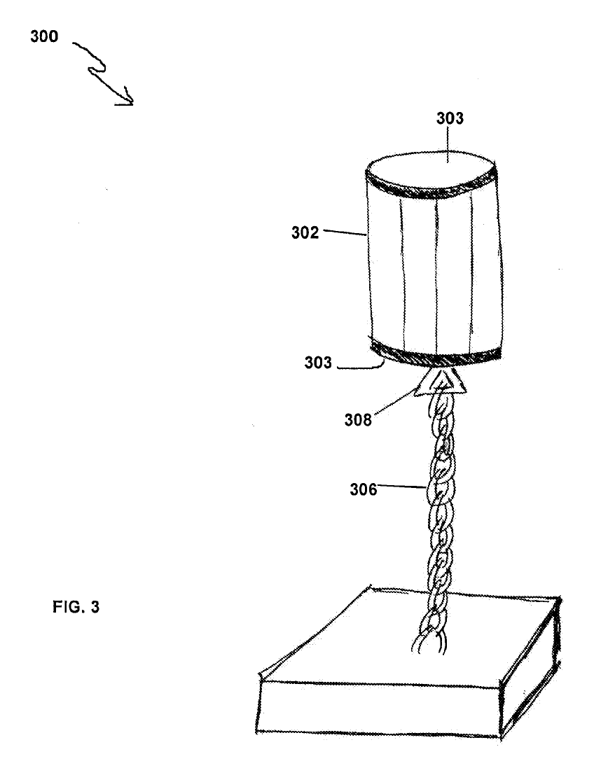

FIG. 3 depicts yet another product-aging apparatus to accelerate an aging process of a product, in accordance with aspects described herein. In this example, container 302 of product-aging apparatus 300 is a cylindrical container having a cylindrical body portion and a head 303 at each end. The coupling apparatus (which includes shackle 308 and metal chain 306) is coupled to container 302 at one of the heads 303 so that the container's buoyancy will cause the container to orient itself vertically in the body of water. In this configuration, movement caused by ocean waves or currents may be focused on the top portion of container 302 if the top end of the container is located in an area of the body of water (e.g. at the surface) with more movement than the area of the body of water at which the bottom end of the container.

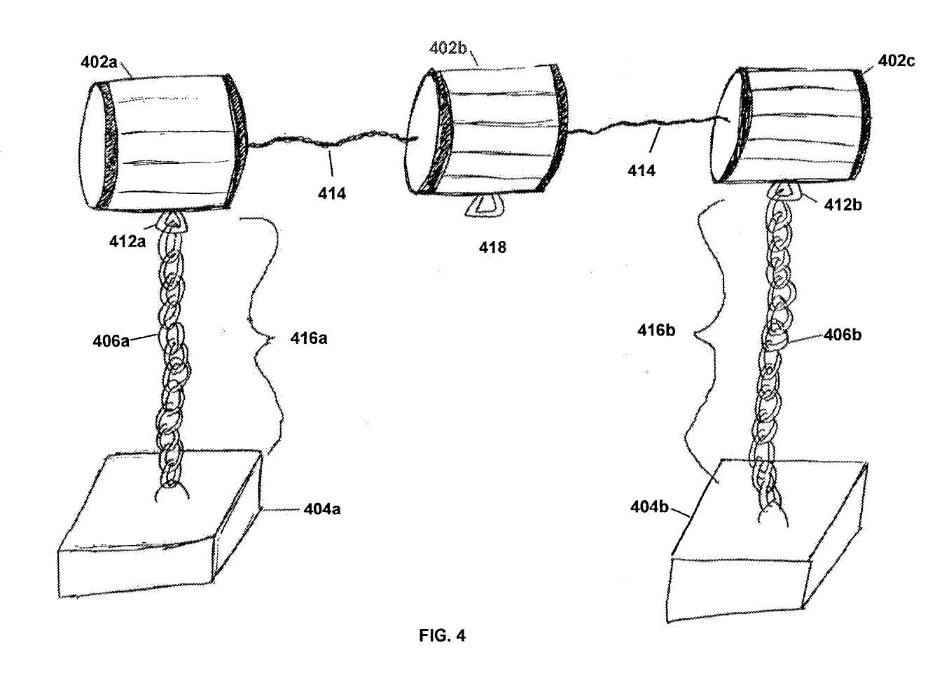

FIG. 4 depicts a further example of a product-aging apparatus to accelerate an aging process of a product, in which multiple containers having one or more products to be aged therein are coupled together, in accordance with aspects described herein. In FIG. 4, containers 402a, 402b, and 402c are coupled in series via tethers 414, which may be, for instance, ropes or metal cables. Coupling apparatus 416a, including shackle 412a and metal chain 406a, couples container 402a to anchor 404a, while coupling apparatus 416b, including shackle 412b and metal chain 406b, couples container 402c to anchor 404b. Agitation in-series may be achieved through the serial linkage of containers 402a, 402b, and 402c. Additionally, shackle 418 is provided as part of (or coupled to) container 402b, demonstrating that a shackle may be provided for each submerged container. This enables, for instance, flexibility in re-configuring the order and placement of the containers in a longitudinal series, if desired.

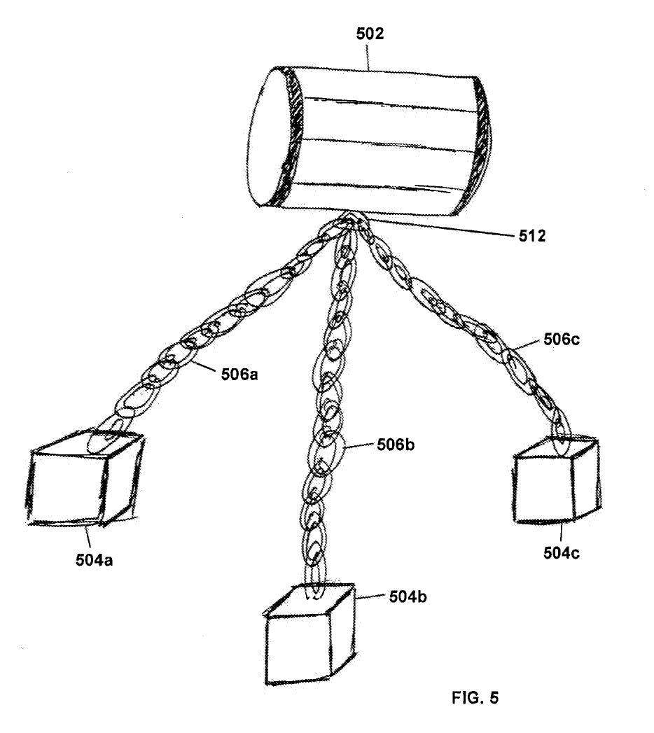

FIG. 5 depicts an example of a product-aging apparatus to accelerate an aging process of a product, in which multiple movable anchoring devices are coupled to a container having a product to be aged therein, in accordance with aspects described herein. In this example, a system of smaller anchors 504a, 504b, and 504c are attached via a coupling apparatus including metal chains 506a, 506b, and 506c, and shackle 512, to container 502. Multiple smaller anchoring devices may be used as here to give maintenance personnel, for instance a dive team, greater control over the placement of the anchors once submerged and/or during the submerging process. The anchors may be light enough to be moved by a team of divers, yet heavy enough to remain substantially stationary in the body of water. This configuration could be useful if it is desirable to move a container from one area of the body of water to another area, for instance from an area (e.g. a calm area) providing one level of agitation to an area (e.g. having more current) providing a different level of agitation.

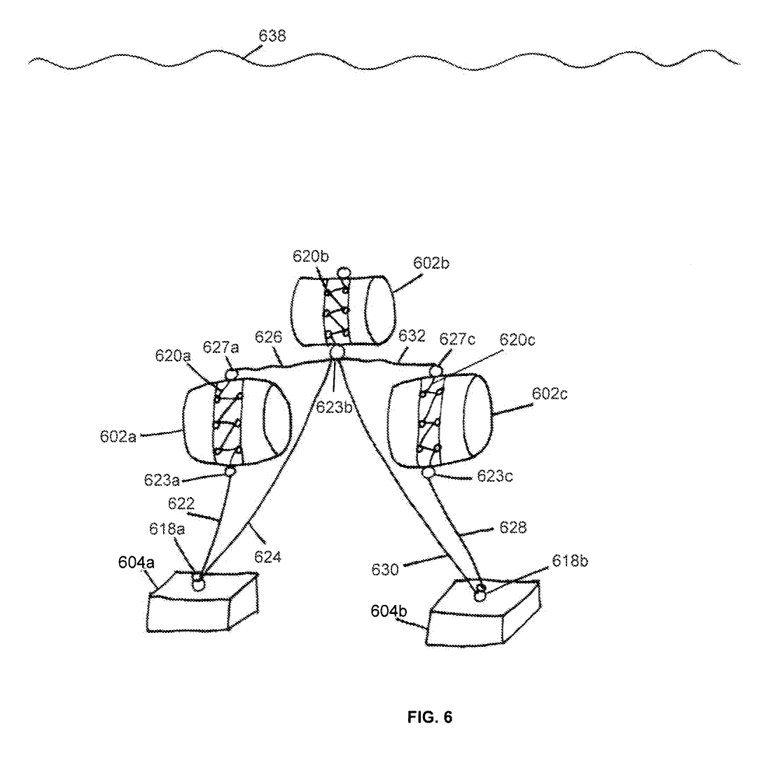

FIG. 6 depicts another example of a product-aging apparatus to accelerate an aging process of a product therein, in which multiple containers having one or more products to be aged are coupled together, in accordance with aspects described herein. In this configuration, two anchoring devices 604a and 604b, which may be deployed on an ocean floor, tether containers 602a, 602b, and 602c.

Container 602a is tethered to anchor 604a by tether 622. Container 602a has a harness 620a (rope harness or metal cable harness as examples) wrapped around it, harness 620a having a shackle 623a to which tether 622 attaches on one end thereof and attaches, on the other end, to a rotating shackle 618a of anchor 604a. Rotating shackle 618a may be made of marine-grade metal or other suitable material. Rotating shackle 618a may be configured to allow partial or complete rotational movement of tethers 622 and 624 with respect to anchor 604a. Similarly, container 602b is tethered to anchor 604a by tether 624 (which may be longer than tether 622), and container 602b also has a harness 620b (rope harness or metal cable harness as examples) wrapped around it and having a shackle 623b to which tether 624 attaches on one end thereof and attaches, on the other end, to rotating shackle 618a of anchor 604a. In one embodiment, tether 622 and 624 are one contiguous tether that attaches, at one end, to shackle 623a of harness 620a, threads through rotating shackle 618a (or eyelet thereof), and attaches, at the other end of the tether, to shackle 623b of harness 620b. Containers 620a and 620b are also tethered to one another via tether 626 which extends between shackle 627a of harness 620a and shackle 623b of harness 620b. In one embodiment, tether 626 is contiguous with tether 632 (see below), in that it may run from container 602a to container 602c while being attached to container 602b. For instance, it may be tied or otherwise fixedly attached to, for instance, shackle 623b, rather than simply fed through 623b, to result in greater agitation. Thus, in that embodiment, the inter-barrel connection of 626 and 632 is tied (in this example to 627a, 623b and 627c, to take advantage of direct agitation and indirect agitation. That is, the containers are subject to movement of the ocean (direct, nautical agitation) and are also subject to each other's movement (indirect agitation). This may includes any vertical or horizontal configuration and any container shape or size, especially when containing a spirit.

Continuing with the description of FIG. 5, container 602c is tethered to anchor 604b by tether 628. Container 602c has a harness 620c (rope harness or metal cable harness as examples) wrapped around it, the harness 620c having a shackle 623c to which tether 628 attaches on one end thereof, and which attaches, at the other end, to rotating shackle 618b of anchor 604b. Rotating shackle 618b, like 618a, may be made of marine-grade metal or other suitable material, and may also be configured to allow partial or complete rotational movement of tethers 628 and 630 with respect to anchor 604b. Container 602b is also tethered to anchor 604b, by tether 630 (which may be longer than tether 628), which attaches shackle 623b of harness 620b to rotating shackle 618b. In one embodiment, tether 628 and 630 are one contiguous tether that attaches, at one end, to shackle 623b off harness 620b, threads through rotating shackle 618b (or an eyelet thereof), and attaches, at the other end of the tether, to shackle 623c of harness 620c. Containers 602b and 602c are also tethered to one another via tether 632 that extends between shackle 627c of harness 620c and shackle 623b of harness 620b.

In the configuration of FIG. 6, movement of one of the containers may cause movement of each of the other containers based on the containers being tethered together (indirect agitation). Consequently, agitation focused on only a single container may still cause agitation of the other containers.

Further, a harnesses (620) may run crisscross around the container and be made by running two parallel ropes (or other connection apparatus) tightly around the container to ensure security of the container. A loop is then made around one of the two parallel ropes (the two that are in direct contact with the container) and then runs diagonally to a point on the other rope, an additional loop is made and this process continues until it has gone around the container. The connection loops (for purpose of connecting to other container (s) and to the anchor(s)) are made on opposite ends of the container.

In some embodiments, the harnesses 620a, 620b, 620c may be configured to minimize an amount of abrasion (driven by movement of the body of water causing the harness to grind against the container) to the container housing the product to be aged.

In an example embodiment: anchors 604a and 604b reside approximately 60 feet below a surface 638 of the body of water in which the components are submerged; tethers 622 and 628 are approximately 10 feet long, tethers 624 and 630 are approximately 15 feet long, and container 602b resides approximately 45 feet below surface 638. Further, although the middle container 602b is depicted as being strung higher than the other two containers, this may not always be the case. Other variations of this formation (including but not limited to adding more of containers or increasing/decreasing the length of the tether(s)) are contemplated in accordance with aspects described herein.

Configurations described and depicted with reference to FIGS. 1-6 may be provided in combination with each other. In any case, agitation of the container(s) included in the product-aging apparatus as a result of movement of the body of water can accelerate an aging process of the product(s) being aged.

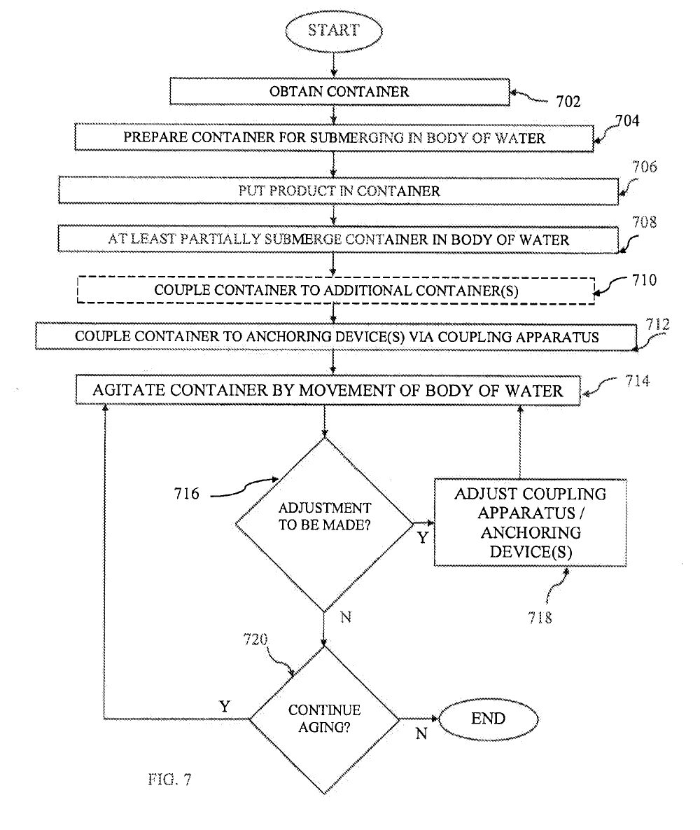

Thus, in accordance with aspects described, processes are provided to accelerate an aging process of a product. FIG. 7 depicts an example of such an aging process. The process begins by obtaining a container (702) and preparing the container for submerging in a body of water (704). In some examples, this preparation includes providing the container with a waterproof or water-repellent barrier to, for instance, inhibit contamination of the product by a body of water.

Next, after the product to be aged has been put into the container (706), the container is at least partially submerged in a body of water (708). In some examples, the container is fully submerged in the body of water, in which the container is submerged beneath a surface of the body of water. The container may optionally be coupled to additional container(s) (710) to form a plurality of coupled containers having product(s) to be aged therein. In these examples, the plurality of coupled containers are at least partially submerged in the body of water.

The container is then coupled to anchoring device(s) via a coupling apparatus (712). The anchoring device(s) and the coupling apparatus may be operatively configured to limit movement of the container relative to the anchoring device(s) when the container is at least partially submerged in the body of water.

Movement of the body of water causes agitation (714) of the container when the container is at least partially submerged in the body of water. The movement may be tidal movement, in the case where the body of water is an ocean. The agitation may accelerate an aging process of the product in the container. This aging process includes the product acquiring characteristic(s) when aged within the container, and the agitation of the container when the container is at least partially submerged in the body of water accelerates this aging process of the product to acquire the characteristic(s). The characteristic(s) can include flavor, aromatic, color, or body characteristics, as examples.

While many different products may benefit from an accelerated aging process as described herein, example products include consumable beverages, such as alcoholic beverages. Example alcoholic beverages include spirits, wine, or beer.

Returning the FIG. 7, the process further includes determining whether an adjustment is to be made to the coupling apparatus and/or to the anchoring device(s) (716). If so, the process continues by with an adjustment the coupling apparatus and/or anchoring device(s) (718) to achieve, for instance, a desired level of agitation of the container by the movement of the body of water, or to achieve a desired level of buoyancy of the container beneath the surface of the body of water. In some embodiments, the anchoring device(s) include multiple anchoring devices, and the multiple anchoring devices are moved in-situ when the container is at least partially submerged in the body of water to position the multiple anchoring devices to achieve a desired level of agitation of the container by the movement of the body of water. After the adjustment is made, the process returns to (714) where the container is further agitated by movement of the body of water.

If at (716) it was determined that no adjustment is to be made, the process continues by determining whether aging is to continue (720). If aging is to continue, the process returns to (714) where the container is further agitated by movement of the body of water. Otherwise, if aging is not to continue, then the process ends. In one example, the container is removed from the body of water and the product is extracted therefrom.

Further, in accordance with aspects described herein, a product-aging apparatus is provided to accelerate an aging process. The product-aging apparatus includes a container having a product to be aged therein, one or more anchoring device(s), and a coupling apparatus coupling the container to the anchoring device(s). One or more additional containers may be coupled to the container to form a plurality of coupled containers having one or more products to be aged therein.

The anchoring device(s) and the coupling apparatus may be operatively configured to limit movement of the container relative to the anchoring device(s) when the container is at least partially submerged in a body of water, and to enable, based on movement of the body of water, agitation of the container when the container is at least partially submerged in the body of water. The agitation may accelerate an aging process of the product in the container.

The coupling apparatus can include a tether configured to tether the container to the anchoring device(s). The tether may be made of one (or more) of a wire, cable, rope, chain, or cord, as examples, and may further include one or more shackles. In some examples, the coupling apparatus includes a net that is configured to contain the container when the container is at least partially submerged in the body of water. The coupling apparatus may additionally or alternatively include a buoyancy-adjusting device configured to facilitate adjusting buoyancy of the container when the container is at least partially submerged in the body of water. The buoyancy-adjusting device may be part of a strap or belt that surrounds the submerged container.

The container may be a substantially cylindrical container having a cylindrical body and a head at an end of the cylindrical container. The coupling apparatus may be coupled to the head of the cylindrical container, for instance to cause the container to orient itself in a desired (e.g. vertical) position under water. In another example, the container could be of any other shape that is connectable to the coupling apparatus and provides accelerated aging of a product due to agitation provided by currents of other movement of a body of water.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The description of the present invention has been presented for purposes of illustration and description, but is not intended to be exhaustive or limited to aspects of the invention in the form disclosed. Many modifications and variations will be apparent to those of ordinary skill in the art without departing from the scope and spirit of aspects of the invention. The embodiment was chosen and described in order to best explain aspects of the principles of the invention and the practical application, and to enable others of ordinary skill in the art to understand aspects of the invention for various embodiments with various modifications as are suited to the particular use contemplated.

What is claimed is:

1. A method to accelerate an aging process, the method comprising:
at least partially submerging in a body of water a container having a product to be aged therein; and
coupling the container to at least one anchoring device via a coupling apparatus, wherein the at least one anchoring device and the coupling apparatus are operatively configured to limit movement of the container relative to the at least one anchoring device when the container is at least partially submerged in the body of water, and wherein movement of the body of water causes agitation of the container when the container is at least partially submerged in the body of water, the agitation accelerating an aging process of the product in the container.

2. The method of claim 1, wherein the aging process comprises the product acquiring at least one characteristic when aged within the container, and wherein the agitation of the container when the container is at least partially submerged in the body of water accelerates the aging process of the product to acquire the at least one characteristic.

3. The method of claim 2, wherein the at least one characteristic comprises at least one flavor characteristic or at least one aromatic characteristic.

4. The method of claim 1, wherein the product comprises a consumable beverage.

5. The method of claim 4, wherein the consumable beverage comprises an alcoholic beverage.

6. The method of claim 5, wherein the alcoholic beverage comprises a spirit.

7. The method of claim 5, wherein the alcoholic beverage comprises wine or beer.

8. The method of claim 1, wherein the body of water is an ocean.

9. The method of claim 8, wherein movement of the ocean comprises tidal movement.

10. The method of claim 1, wherein the at least partially submerging comprises fully submerging the container in the body of water, in which the container is submerged beneath a surface of the body of water.

11. The method of claim 10, wherein the method further comprises adjusting the coupling apparatus to achieve a desired level of agitation of the container by the movement of the body of water or to achieve a desired level of buoyancy of the container beneath the surface of the body of water.

12. The method of claim 1, further comprising providing the container with a waterproof or water-repellent barrier to inhibit contamination of the product by the body of water.

13. The method of claim 1, further comprising:
coupling the container to one or more additional containers to form a plurality of coupled containers having one or more products to be aged therein; and
at least partially submerging the plurality of coupled containers in the body of water.

14. The method of claim 1, wherein the at least one anchoring device comprises multiple anchoring devices, and wherein the method further comprises moving the multiple anchoring devices in-situ when the container is at least partially submerged in the body of water to position the multiple anchoring devices to achieve a desired level of agitation of the container by the movement of the body of water.

15. A product-aging apparatus to accelerate an aging process, the product-aging apparatus comprising:
a container having a product to be aged therein;
at least one anchoring device; and
a coupling apparatus coupling the container to the at least one anchoring device, the at least one anchoring device and the coupling apparatus operatively configured to limit movement of the container relative to the at least one anchoring device when the container is at least partially submerged in a body of water, and to enable, based on movement of the body of water, agitation of the container when the container is at least partially submerged in the body of water, the agitation accelerating an aging process of the product in the container.

16. The product-aging apparatus of claim 15, wherein the coupling apparatus comprises a tether configured to tether the container to one or more anchoring devices of the at least one anchoring device.

17. The product-aging apparatus of claim 16, wherein the tether comprises one of a wire, cable, rope, chain, or cord.

18. The product-aging apparatus of claim 17, wherein the coupling apparatus further comprises at least one shackle.

19. The product-aging apparatus of claim 15, wherein the coupling apparatus comprises a net configured to contain the container when the container is at least partially submerged in the body of water.

20. The product-aging apparatus of claim 15, wherein the coupling apparatus comprises a buoyancy-adjusting device configured to facilitate adjusting buoyancy of the container when the container is at least partially submerged in the body of water.

21. The product-aging apparatus of claim 15, wherein the container is a cylindrical container comprising a cylindrical body and a head at an end of the cylindrical container, and wherein the coupling apparatus is coupled to the head of the cylindrical container.

22. The product-aging apparatus of claim 15, further comprising one or more additional containers coupled to the container to form a plurality of coupled containers having one or more products to be aged therein.
